(19) United States
(12) Patent Application Publication
(10) Pub. No.: US 2007/0232172 A1
(43) Pub. Date: Oct. 4, 2007

(54) Upholstering foam body, particularly for vehicle seats

(76) Inventor: Ernst Kurt Biermann, Plauen (DE)

Correspondence Address: MILDE & HOFFBERG, LLP, 10 BANK STREET, SUITE 460, WHITE PLAINS, NY, 10606, US

(21) Appl. No.: 11/726,836

(22) Filed: Mar. 22, 2007

(30) Foreign Application Priority Data
Apr. 4, 2006 (DE) 10 2006 016 107.6

(51) Int. Cl. B32B 5/24; B32B 5/26; B32B 3/26; B32B 5/18

(52) U.S. Cl. 442/221; 428/304.4; 442/224; 442/315

(57) ABSTRACT

An upholstering foam body is disclosed with a structural body (2) forming a hollow cavity that is at least partially embedded into the material of the foam body (1).

### BACKGROUND OF THE INVENTION

The invention relates to a upholstering foam body, particularly for vehicle seats, per the overall concept of patent claim 1.

In connection with upholstering foam bodies, it is known for weight-saving reasons to insert flexible, inflatable shells, e.g., balloon-type cushions, that in their immediate vicinity compress the foam material and form hollow cavities. A problem with such inflatable cushions is that they are relatively easily damaged by sharp objects so that they collapse, whereby the foam body loses its supportive and upholstering function in this area.

### SUMMARY OF THE INVENTION

It is the principal object of the invention to provide a light-weight but stable foam body.

This object, as well as other objects which will become apparent from the discussion that follows, are achieved, in accordance with the present invention, by embedding a hollow structural body that forms a hollow cavity in the material of the foam body. Preferably, the structural body is formed by a knitted or woven spacer fabric.

The significant advantage of the present invention consists of the fact that the upholstering foam body includes a firm, flexible, and stable structural body that forms a hollow cavity as an integral component. Thus, the amount of foam material is reduced in the foam body in the area of the firm structural body. The foam body therefore advantageously possesses less weight. In case of fire, smoke production is significantly reduced. Since it contains less foam material, the toxicity of the foam body, which depends on the resulting emissions when the foam material is burned, is considerably reduced.

An additional significant advantage of the foam body based on the invention is that it can breathe, whereby air exchange is possible within the depth of the structural body because of the coarse porosity of the foam, and particularly because of holes or channels cut into the foam material. Since the structural body is elastic and yields under load, a pumping effect arises that ensures that the whole foam body and the structural body are actively provided fresh air.

These foam bodies enjoy particularly advantageous application in combination with vehicle seats, whereby the structural body is positioned in the area of the central seat surface of vehicle seats and/or the central areas of the seat backs of vehicle seats. This particularly plays a major role in aircraft during long intercontinental flights.

For a full understanding of the present invention, reference should now be made to the following detailed description of the preferred embodiments of the invention as illustrated in the accompanying drawings.

### BRIEF DESCRIPTION OF THE DRAWINGS

FIG. 1 schematic cutaway view of a foam body based on the invention.

FIG. 2 enlarged view to clarify the embedding of the structural body into the foam material of the foam body.

FIGS. 3-5 advantageous embodiments of the foam body based on the invention.

FIG. 6 the manner of application of the foam body based on the invention in a vehicle seat.

### DESCRIPTION OF THE PREFERRED EMBODIMENTS

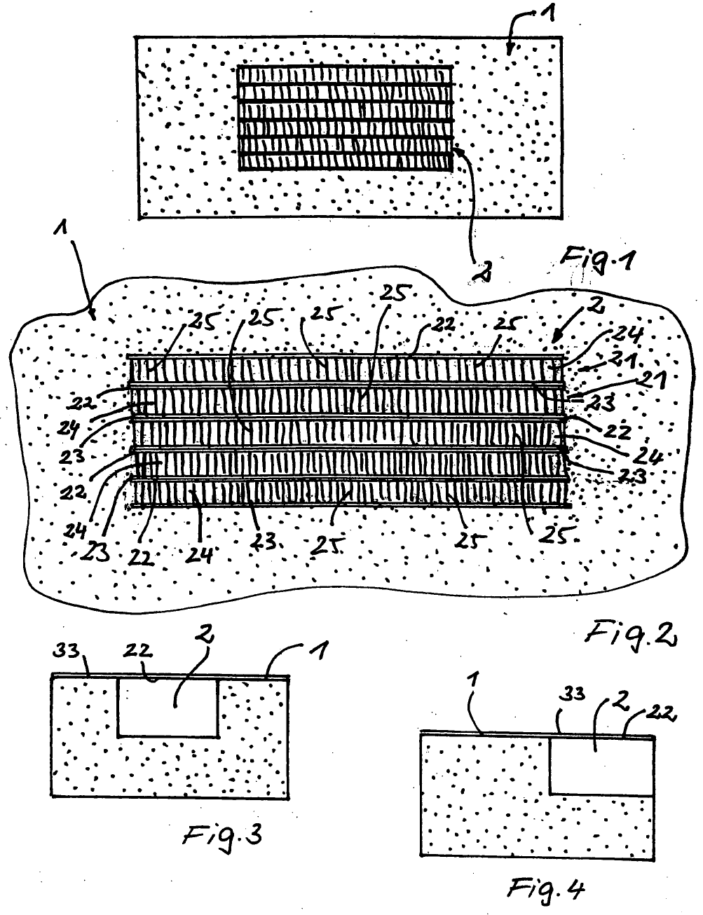

The preferred embodiments of the present invention will now be described with reference to FIGS. 1-6 of the drawings. Identical elements in the various figures are designated with the same reference numerals.

FIG. 1 shows a upholstering foam body that, for example, consists of a coarse-porosity foam, designated with 1. A flexible, hollow structural body 2 is embedded in (in the case of FIG. 1, and completely surrounded by) the foam body 1 that, for example, includes several layers of knitted spacer fabric, as FIG. 2 shows more clearly.

Each of the individual knitted spacer fabrics 21 of the structural body 2 consists of an upper layer 22, a lower layer 23, and a spacer layer 24 between them that is formed conventionally by means of individual spar-shaped components 25 connected with the upper layer 22 and the lower layer 23 and extend perpendicular to the surfaces of the upper layer 22 and the lower layer 23, holding them flexibly at a separation from each other. Within the multi-layer structural body 2, each lower layer 23 of a knitted spacer fabric 21 is connected firm and flat with the upper layer 22 of the knitted spacer fabric 21 lying below it, preferably partially adhered. Since the upper layers 22 and the lower layers 23 each include recesses in their surface and are therefore permeable to the air, the overall structural body 2 is thus permeable to the air with active circulation both in the direction perpendicular to the surfaces of the upper and lower layers 22, 23 and the direction parallel to these surfaces.

Since the entire structural body 2 is embedded into the foam material itself during manufacture of the foam body 1, it is firmly connected with the foam body 1. The entire structural body 2 is embedded into, and surrounded by, the foam material when it is cast, and the foam material then hardens.

For example, the knitted spacer fabrics may consist entirely of a polyethylene material. Polyurethane foam may be used as foam material.

Per FIG. 3, it is conceivable to position the structural body 2 within the foam body 1 so that its upper layer 22 lies approximately within the upper surface of the foam body 1.

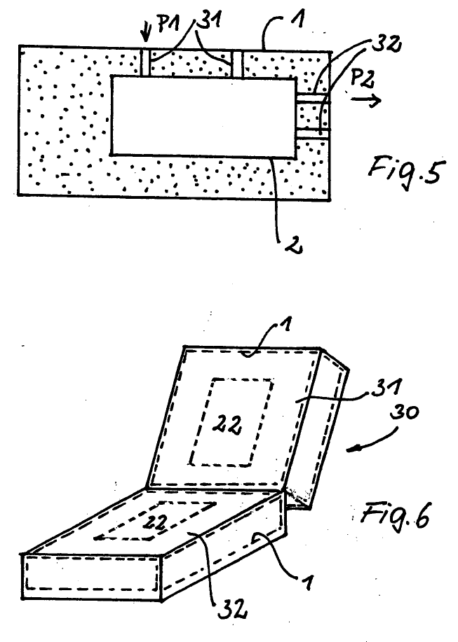

FIG. 4 shows an implementation type of the foam body 1 in which the structural body 2 is so positioned that both its upper layer 22 is exposed to the upper surface of the foam body 1 and its side surface is exposed to a side surface of the foam body 1. Exposure of only one side surface of the foam body 1 is conceivable.

The upper layer of the foam body 1 and the upper layer 22 of the structural body 2 may be covered with an air-permeable covering material 33.

As FIG. 5 shows, air channels 31, 32 from the outer surfaces of the foam body 1 may be included if the structural body 2 is completely embedded within the foam body 1 and is completely surrounded by the material on all sides. These channels 31, 32 extend to the structural body 1, and cause air flow in the directions of the arrows P1, P2 particularly when loaded by pressure from the foam body 1, that may be attributed to a pumping effect. For example, when the foam body 1 is loaded by pressure from above, air is forced downward into the structural body 1 via the channels 31, and is pressed outward by it laterally through the channels 32. When the load is removed from the foam body 1, flow occurs in the opposite direction.

It must be mentioned that the structural body 2 is not limited to the embodiment examples like the one described with the knitted spacer fabrics. For example, flexible, hollow structural bodies are conceivable that consist of woven or knitted fabric that, in any order, hold the upper and lower layers of the structural body 2 apart from each other, and are flexible. Structural bodies are also conceivable that include springs like a mattress in order to hold the upper and lower layers apart from each other. Moreover, the structural body may also be formed using a one-piece knitted spacer fabric that is of such dimensions that a pre-determined, relatively large separation between the layers 22 and 23 is achieved. Another alternative consists of forming the hollow structural body 2 using a flexible plastic foam block or a flexible plastic fiber block. For this, each block possesses a pre-determined stability, strength, and air permeability. For example, polyethylene, polyamide, or polyester are suitable as plastic materials for the foam or for the fibers.

In the following, in connection with FIG. 6, the use of this foam body 1 in connection with a vehicle seat, particularly an aircraft seat, will be described in greater detail. The advantages of the invention mentioned at the outset (light weight of upholstering body, low flammability and reduced smoke production, reduced toxicity) play a particularly large role for aircraft seats. As shown schematically, these upholstering foam bodies 1 are located within a vehicle seat 30 in the central areas of the seat body 32 and/or of the seat back 31 under a covering material, whereby the structural bodies 1 are so mounted within the foam material of the foam body 1 that they are located within or below or behind the central areas of the seat surface of the seat body 32 or of the back surface¹ of the seat back in order to provide particularly good air circulation there.

It must be mentioned that this foam body may also be used in other manners, e.g., in connection with furniture, clothing, etc.

There has thus been shown and described a novel upholstering foam body, particularly for vehicle seats which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. An upholstering foam body with a structural body forming a hollow cavity, said structural body being at least partially embedded in foam material of the foam body.

2. Foam body as in claim 1, wherein the structural body is completely embedded within the foam material of the foam body.

3. Foam body as in claim 1, wherein the structural body is embedded within the foam material of the foam body such that a surface of the structural body is located within a surface of the foam body.

4. Foam body as in claim 1, wherein the structural body is embedded within the foam material of the foam body such that at least one of its side surfaces is positioned within a plane defined by a side surface of the foam body.

5. Foam body as in claim 1, wherein at least one of its surfaces is covered by a covering material.

6. Foam body as in claim 1, wherein the structural body includes an upper layer and a lower layer that are held in spaced apart relationship by a material selected from the group consisting of knitted fabric, woven fabric, and springs.

7. Foam body as in claim 1, wherein the structural body includes at least one knitted spacer fabric with an upper layer and a lower layer, whereby the upper layer and the lower layer are held apart by spacer elements.

8. Foam body as in claim 7, wherein the structural body consists of a plurality of knitted spacer fabrics, one arranged upon the other, and wherein each lower layer of a knitted spacer fabric is connected with an upper layer of the next knitted spacer fabric immediately below it.

9. Foam body as in claim 8, wherein the lower layer of one knitted spacer fabric is at least partially adhered to the upper layer of the next knitted spacer fabric immediately below it.

10. Foam body as in claim 1, wherein the foam material is polyurethane foam.

11. Foam body as in claim 1, wherein the knitted spacer fabric is formed of polyethylene.

12. Foam body as in claim 1, wherein the structural body is a block formed by at least one of plastic foam and plastic fibers.

13. Foam body as in claim 12, wherein said plastic foam and said plastic fibers consist essentially of at least one of polyethylene, polyamide, and polyester.

14. Foam body as in claim 1, wherein channels are provided within the foam body that provide an air path between the outer side of the foam material and the structural body.

15. Foam body as in claim 14, wherein the channels extend to various sides of the structural body.

16. A vehicle seat with at least one of a seat body and a seat back, the improvement wherein a foam body is mounted within at least one of the seat body and the seat back; wherein the structural body is located in at least one of the central area of the seat surface of the seat body and the central area of the back surface of the seat back.
